(19) United States
(12) Patent Application Publication
(10) Pub. No.: US 2016/0080902 A1
(43) Pub. Date: Mar. 17, 2016

(54) MOBILE COMMUNICATION DEVICE INCLUDING POSITIONING MEANS AND METHOD FOR USING POSITIONING COORDINATES TO AUTOMATICALLY SERVE SERVICE PERSONNEL WITH MACHINE SERVICE INFORMATION

(71) Applicant: Aktiebolaget SKF, Göteborg (SE)

(72) Inventor: Theo DU PLESSIS, Den Bosch (NL)

(21) Appl. No.: 14/784,965

(22) PCT Filed: Apr. 25, 2013
(86) PCT No.: PCT/EP2013/058614

§ 371 Date: Oct. 16, 2015

(51) Int. Cl. H04W 4/02; G05B 23/02; F03D 7/00

(52) U.S. Cl. CPC H04W 4/023; F03D 7/00; G05B 23/0216

(57) ABSTRACT

A portable communication device including a processor and application software for managing data relating to one of: a maintenance check or service check of multiple distributed machines, a database storing position coordinates of the distributed machines to be checked and a positioning system for determining position coordinates of the portable communication device. The application software is configured to identify the machine being checked based on a comparison of the position coordinates of the distributed machines with the position coordinates of the portable communication device, and to select machine-specific machine service information relating to the identified machine.

### CROSS REFERENCE TO RELATED APPLICATIONS

This is a United States National Stage Application claiming the benefit of International Application Number PCT/EP2013/058614 filed on 25 Apr. 2013 (25.04.2013), which is incorporated herein by reference in its entirety.

### TECHNICAL FIELD

The invention relates to a portable communication device including positioning means and application software for managing service and maintenance tasks for a machine in a network of distributed machines to be monitored or serviced, in particular a network of wind power plants.

### TECHNICAL BACKGROUND

Condition monitoring systems for wind turbines are widely used in the wind energy market, wherein one of the systems is known as the SKF WindCon system.

Modern wind turbine generators have grown to be more and more complex and are often located in places such as off-shore wind parks, which are difficult to access. In order to reduce downtime to a minimum and to improve performance and reliability, maintenance and service tasks have to be carried out in a reliable and efficient way such that small problems may be detected before they lead to major breakdowns.

On present and future off-shore installations, the cost of getting to the wind turbines may be considerable such that it is important to avoid missing essential steps once the maintenance personnel has entered the nacelle.

Further, the increasing size of wind parks leads to an increasing risk of confusion. The human service worker may mix up a service schedule for one turbine with the service schedule for another turbine, store notes, images, sound files in the central data server under the wrong turbine identification number or even forget to store the data collected or images taken in the course of the inspection entirely.

Actually, the service worker is provided with a schedule or checklist for his service or maintenance tasks when he leaves his office or workshop and may reach the turbine hours of even days later. As a consequence, his schedule might be outdated and incomplete. Since regular mobile telecommunication networks are usually not available e.g. in off-shore wind energy parks, calling or alerting the service worker via telephone may not be possible or, when using satellite communication, very expensive.

### SUMMARY OF THE INVENTION

The invention seeks to avoid the above problems by making use of a positioning means or positioning function provided in a portable communication device carried by the service worker for the identification of the machine to be serviced or monitored as detailed in the independent claims. Further features and favorable embodiments are defined in the dependent claims and in the specification.

The invention starts from a portable communication device including a processor and application software for managing machine service information relating to a maintenance or service checks of multiple distributed machines, a database storing position coordinates of the distributed machines to be checked and positioning means for determining the position coordinates of the portable communication device.

It is proposed that the portable communication device is configured so as to identify the machine being serviced based on a comparison of the position coordinates of the distributed machines with the position coordinates of the portable communication device, and to select machine-specific machine service information relating to the identified machine.

The machines being serviced or monitored could be wind turbines, distributed machines on a large factory site or any other network of remote machines to be controlled centrally. The portable communication device could be a laptop computer, a cellular phone, a tablet computer or any other electronic device capable of exchanging electronic data with the network to be monitored.

It is proposed that the portable communication device is configured so as to identify the machine to be serviced or monitored based on positioning data or coordinates retrieved by the positioning means and to select maintenance data, machine service information or monitoring data based on this selection.

The automatic selection of the machine service information avoids an unintended mixing up or confusion between machine service information pertaining to different machines. The machine service information may include identification data and technical specifications of the machine, maintenance protocols, service schedules, checklists, data on the machine history and curves describing trends in state quantities of the machine such as temperature, vibration amplitudes and the like.

The positioning means may comprise a receiving unit for receiving data from a satellite-based positioning system such as GPS or GALILEO or from a local positioning system including and using e.g. antennae on at least some of the towers of a wind park.

The machines to be controlled may be provided with at least one sensor for measuring condition data of the machine. The sensors may include temperature sensors, vibration sensors, acceleration sensors, rotation sensors, pressure sensors, cameras or any other suitable sensors used for monitoring mechanical, electro-mechanical or electronic machines.

Further, the machines being serviced or monitored may include a monitoring unit for receiving and processing the condition data from at least one sensor, wherein the communication link between the machines being serviced or monitored and the central control server is established via the monitoring unit.

The automatic update ensures that the service information, which may include service schedules, checklists and the like, is up to date in the moment where the service personnel reaches the machine to be monitored or serviced and errors due to outdated data or machine service information can be safely avoided.

It is further proposed that access information for connecting the portable communication device to the monitoring unit is calculated using the geographical coordinates of the machine to be serviced or monitored or identification data determined using the geographical coordinates. This access information may include passwords, encryption keys and instructions for establishing the connection. This holds in particular where service information used and displayed on the portable communication device is created or updated based on the updated condition data.

The easy and basically fully automatic connection is particularly useful in the field of wind turbine monitoring because the service tasks may require access by service workers of various professions, nationalities and different companies.

Data obtained or generated during the service may be temporarily stored on the portable communication device in connection with identification data of the machine or wind turbine and uploaded to a remote central control server once the portable communication device is able to establish a communication connection to the server.

Enabling data exchange may include downloading machine information from the central control server, wherein the portable communication device may be configured to add the identification data obtained using the positioning means to the download request triggered by the portable communication device such that it is always ensured that the machine information relating to the correct machine is downloaded.

Further, the data exchange may include uploading data generated by the portable communication device to the central control server, wherein the monitoring unit may be configured to add the identification data obtained using the positioning means to the uploaded data such that the data is surely stored in the data section pertaining to the correct machine and nothing is mixed up.

Data to be uploaded may include photographs taking by parts of the machine, in particular wear parts, sound files with voice news or noises of the machine recorded by the portable communication device, movies, written notes or the like.

Preferably, the communication between the portable communication device and the monitoring unit is encrypted such that the confidentiality of the data exchange is maintained.

In a further preferred embodiment of the invention, the portable communication device is equipped with a buffer memory for temporarily storing data to be submitted to the central control server while the communication link is down. This data being temporarily stored may include the regular monitoring data recorded by the sensors as well as the additional data submitted by the portable communication device according to the invention.

Finally, the invention proposes a portable communication device for use in a condition monitoring system as described above, wherein the communication device is provided with positioning means and appropriate application software for identifying the machine to be serviced or monitored based on the coordinates determined by the positioning means.

A further aspect of the invention relates to a method for servicing machines in a network of distributed machines having a condition monitoring system as described above, the method including the steps of, determining the position coordinates of the portable communication device using a positioning means of the latter and selecting machine service information of a machine to be serviced or monitored based on the position coordinates.

The above description of the invention as well as the appended claims, figures and the following description of preferred embodiments show multiple characterizing features of the invention in specific combinations. The skilled person will easily be able to consider further combinations or sub-combinations of these features in order to adapt the invention as defined in the claims to his or her specific needs.

### BRIEF DESCRIPTION OF THE DRAWINGS

FIG. 1 is a schematic view of an off-shore wind turbine in a large area wind energy park and of a monitoring system for monitoring the turbines in this park.

FIG. 2 s a schematic view of a monitoring unit installed inside the nacelle of the turbine of FIG. 1 and of a mobile phone as a portable communication device.

### DETAILED DESCRIPTION OF THE EMBODIMENTS

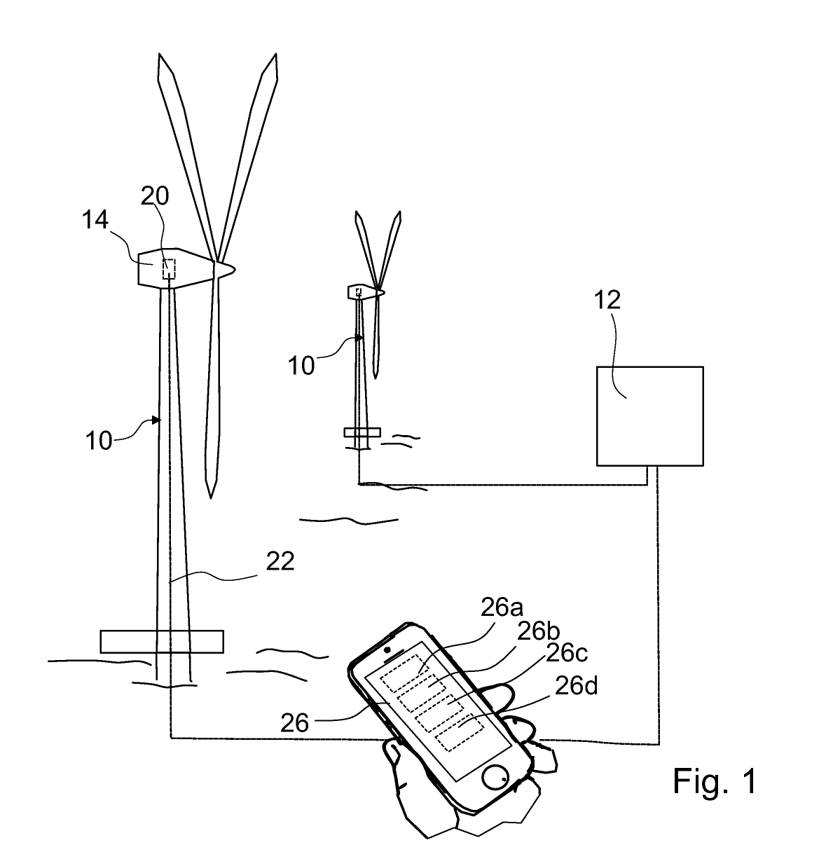

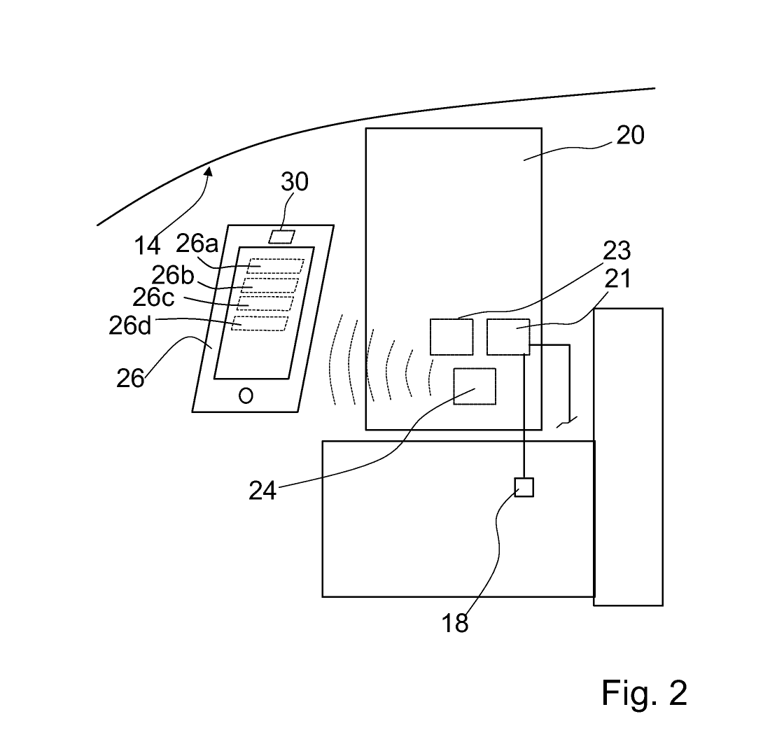

FIGS. 1 and 2 illustrate a condition monitoring system and a method according to the invention. The condition monitoring system includes a network of distributed wind turbines 10 as a network of distributed machines to be monitored and a central control server 12 located in a control room of the network, which may be on the land, whereas the turbines 10 are installed off-shore in this example.

The turbines include a nacelle 14. The nacelle 14 is a housing receiving a generator, bearings and transmission gears (not shown) necessary for the operation of the turbine 10 and for generating electricity out of the wind power.

A fixed, wire-bound communication link 22 is provided between the machine 10 and the central control server 12.

The standard service procedure in the prior art includes providing the service personnel with checklists, a service schedule or the like on paper, wherein the service worker notes his or her observations on the paper, takes photographs of critical components, wear parts or the like using a portable camera and the thus collected information has to be manually added to a database of the wind turbine system maintained in the server 12. The checklists or service schedules are prepared before the service worker leaves his office.

The invention proposes that the service workers should use, as a replacement for the paper documents or in addition to these, a portable communication device 26 such as a tablet computer, a smart phone or a notebook computer.

Service personnel approaching the machine 10 to be serviced are equipped with a mobile portable telecommunication device 26 as shown in FIGS. 1 and 2.

FIGS. 1 and 2 illustrate the case where a mobile phone 26 is used as the portable communication device 26. The mobile phone comprises a processor 26a, a memory unit storing a database 26b and a positioning means formed as a GPS receiver 26c. Application software for managing the maintenance and service data needed during the service checkup or other tasks is installed on the mobile phone 26.

The application software has access to the database 26b. The database 26b stores geographical coordinates of the machines 10 being serviced or monitored as position coordinates in combination with identification data (ID numbers) and machine-specific machine service information such as checklists, technical specifications and history data of the machine.

While the application software is running, the processor 26a is configured to determine the position coordinates of the portable communication device 26 using the positioning means 26c of the portable communication device 26. This positioning process may be performed in a periodically repeated manner or triggered by a request of the user.

Once the geographical coordinates of the portable communication device 26 are determined, the application software calculates the distances to each machine out of a set of machines being serviced or monitored and identifies the machine located at the nearest distance as the machine to be serviced or monitored, provided that the distance is smaller than a threshold value. The threshold value can be set dependent on the field of application. For wind turbines, values between 20 and 50 m are preferred.

Once the machine is identified, the application software selects machine-specific machine service information of the identified machine to be serviced or monitored based on the position coordinates or based on the identification number determined based on the coordinates. In an alternative embodiment of the invention, the automated selection of the machine to be serviced or monitored may be complemented by a manual confirmation step.

The machine-specific machine service information includes in particular a checklist and/or technical specifications of the machine.

Multiple sensors such as a sensor 18 (FIG. 2) for measuring the temperature of the generator (not shown) as well as other temperature sensors, rotation sensors, vibration sensors and acceleration sensors are mounted at critical points of the turbine 10 inside and/or outside the nacelle 14 for monitoring purposes.

The sensors 18 are connected to a monitoring unit 20 mounted inside the nacelle 14, which records and processes the sensor signals received from the sensors 18.

The monitoring unit 20 includes a processor 21 capable of performing various signal processing algorithms such as time wave form analysis, vector analysis, real-time Fourier transforms, digital peak enveloping, integration/derivation both in time and frequency domain, Windowing, etc. as well as the possibility to implement user-formulated mathematical equations based on the obtained results. The results are compared with threshold parameters for triggering alarm signals. Cable fault and sensor fault detection systems are also implemented. The sensor input interfaces of the monitoring unit 20 include multiple analog inputs as well as digital inputs.

The monitoring unit 20 is provided with Ethernet interfaces connected to a communication wire forming a communication link 22 to the central server 12. The communication link uses TCP/IP.

Further, various other interfaces such as an RS 232 service interface for updating the firmware of the processor 21 of the monitoring unit 20 or for reading out data on a solid state memory device 23 of the monitoring unit etc. is also provided.

The invention proposes to optionally provide, preferably in addition to the above, a communication interface 24 for connecting the portable communication device 26 to the monitoring unit 20, wherein “connection” means data exchange connection in this context.

The portable communication device 26 according to the invention may communicate with the central control server 12 via the communication interface 24 and using the fixed communication link 22. This communication channel may be operating even if no connection to the mobile communication network (GPRS, 3G, 4G, LTE or the like) exists in the off-shore wind park. In both the communication using this communication channel and using the regular mobile communication network, the portable communication device 26 uses the same public IP address of the central control server 12. A reconfiguration of the application settings is therefore not required.

The service staff may enter the nacelle 14 of the turbine 10 in order to execute service and maintenance work on a regular basis.

Besides of its telecommunication interface (not shown) and positioning means 26c, the mobile phone 26 is provided with a communication interface formed as a short-range Bluetooth interface. The expression short-range is to be interpreted in the context of the application so as to safely cover the typical distances of the service worker to the machine to be serviced or monitored but preferably not overlapping with the range of wireless communication interfaces in neighboring machines being serviced or monitored. For wind turbines 10, it is sufficient if the signals of the wireless communication interface 24 can be received inside the nacelle 14, at most at the access platform at the bottom of the turbine tower, such that the range should be of the order of the height of the tower. The range of this connection to the monitoring unit 20 may be smaller than the threshold distance used for the machine identification.

The monitoring unit 20 is arranged in a wall-mounted box in the embodiment of FIG. 2.

Once the service worker enters the range of the wireless communication interface 24 and the portable communication device 26 carried by him receives the signals of communication interface 24, the application software installed on the portable communication device 26 notifies the holder of the device 26 that wireless access to the monitoring unit 20 is available and creates a communication connection. In the alternative, the communication interface 24 may start sending signals only upon manual activation by the service staff.

The application software in the portable communication device 26 uses the identification number or coordinates of the machine 10 to generate a password or other kind of access information (encryption keys, user name or the like) for establishing an encrypted data connection with the monitoring device 20 in a fully automated way. The password or key is calculated as a predetermined function of the identification number or coordinates of the device 10.

The communication access to the monitoring unit 20 as described above is highly secure the application software on the portable communication device 26 is mandatory for the establishment of the connection. Unentitled persons not having the application software installed on their portable communication devices are unable to access the monitoring device of the machine 10.

Once the data connection to the central control server 12 is established, updated machine information and/or condition data pertaining to the turbine 10 to be maintained or checked is downloaded to the portable communication device 26 and the machine-specific service checklist or service schedule selected based on the geographical coordinates as described above may be automatically updated or filled on the device 26.

In addition to this, the user is free to specifically request the download of any data of interest in the case where these are not included in the automatic update. The machine information and condition data may include long-time trend data, comparisons with other turbines nearby correlation data and other data helping the service worker understand the problems or potential problems of the machine 10 being checked. The portable communication device 26 includes a microphone and the possibility to record voice notes or noise of the generator for documentation purposes as well as the camera 30, which can be used for taking images of parts of interest, e.g. wear parts, damaged parts or the like. Further, notes may be taken in the electronic checklist stored in the portable communication device 26 or elsewhere. The thus produced data files, i.e. image files, sound files or text files with notes are stored in a buffer memory of the portable communication device 26 and may be uploaded to the central control server 12 automatically or upon request by the user once a communication connection to the control server may be established, e.g. by synchronizing the database 26b with the database held in the central control server 12.

In one embodiment of the invention, the user is prompted upon saving the file whether or not he wishes to upload the file to the central control server 12. If he agrees, the data files are transferred to the monitoring unit 20 via the communication interface 24 and the monitoring unit 20 creates a data packet with a header including the machine identification number identifying the turbine 10 being checked, the time and the date and optionally identification information of the service worker such as his name and corporate affiliation.

The upload of data files may be done file by file or in a consolidated way as a packet upon completion of the service or maintenance tasks.

1. A portable communication device including:
a processor operating in accordance with application software for managing machine service information relating to one of a maintenance check or a service check of multiple distributed machines,
a database storing position coordinates of the distributed machines to be checked and positioning means for determining the position coordinates of the portable communication device,
wherein the application software is configured to:
a. identify the machine being serviced based on a comparison of the position coordinates of the distributed machines with the position coordinates of the portable communication device; and
b. elect machine-specific machine service information relating to the identified machine.

2. The portable communication device according to claim 1, wherein the machine-specific machine service information includes at least one of:
a. a checklist associated with the machine; and/or
b. technical specifications of the machine.

3. The portable communication device according to claim 1, wherein the step of identifying the machine being checked further comprises steps of:
calculating a distance to each machine out of a set of machines; and
selecting the machine located at a smallest distance as the machine to be one of serviced or monitored.

4. The portable communication device according to claim 1, wherein the step of identifying the machine being serviced includes steps of:
calculating a distance to at least one machine; and
comparing the distance with a threshold value,
wherein the machine is identified automatically as the machine to be one of serviced or monitored when the distance is smaller than the threshold value.

5. The portable communication device according to claim 1, wherein the application software is configured to prompt a manual confirmation of the automatic identification of the machine to be one of serviced or monitored.

6. The portable communication device according to claim 1, further including a buffer memory for storing data obtained in the course of one of the check-up process or maintenance process in combination with identification data of the machine to be one of serviced or monitored.

7. The portable communication device according to claim 1, further including a communication interface for exchanging data relating to the machine being one of serviced or monitored with the main server.

8. The portable communication device according to claim 1, wherein said communication interface is a wireless communication interface.

9. The portable communication device according to claim 1, further including at least one of:
a. a built in camera, or
b. an audible recording device for recording sound files,
wherein the application software is configured to store at least one of the image data and the sound data obtained by the at least one of the built in camera and the audible recording device in combination with identification data in the database.

10. A condition monitoring system including:
a network of distributed machines to be monitored; and
at least one portable communication device adapted to monitor multiple distributed machines within the network of distributed machines, the at least one portable communication device comprising:
a processor operating in accordance with application software for managing machine service information relating to one of a maintenance check or a service check of multiple distributed machines,
a database storing position coordinates of the distributed machines to be checked and positioning means for determining the position coordinates of the portable communication device,
wherein the application software is configured to:
a. identify the machine being serviced based on a comparison of the position coordinates of the distributed machines with the position coordinates of the portable communication device; and
b. elect machine-specific machine service information relating to the identified machine.

11. The condition monitoring system according to claim 10, wherein the network of distributed machines includes at least one wind turbine.

12. A method for servicing machines in a network of distributed machines of a condition monitoring system, the condition monitoring system comprising at least one portable communication device adapted to monitor multiple distributed machines within the network of distributed machines, the at least one portable communication device comprising:
a processor operating in accordance with application software for managing machine service information relating to one of a maintenance check or a service check of multiple distributed machines,
a database storing position coordinates of the distributed machines to be checked and positioning means for determining the position coordinates of the portable communication device,
wherein the application software is configured to:
a. identify the machine being serviced based on a comparison of the position coordinates of the distributed machines with the position coordinates of the portable communication device; and
b. elect machine-specific machine service information relating to the identified machine,
the method including the steps of:
a. determining the position coordinates of the portable communication device using a position determining portion of the portable communication device, and
a. selecting machine service information of a machine to be one of serviced or monitored based on the position coordinates.
